(19) United States
(12) Patent Application Publication
(10) Pub. No.: US 2013/0052341 A1
(43) Pub. Date: Feb. 28, 2013

(54) ALIGNMENT FILM AND METHOD OF MANUFACTURING THE ALIGNMENT FILM, AND RETARDATION FILM AND METHOD OF MANUFACTURING THE RETARDATION FILM

(71) Applicants: Hirokazu Odagiri, Miyagi (JP); Mitsunari Hoshi, Miyagi (JP); Shinya Suzuki, Miyagi (JP); Jiro Nozaki, Miyagi (JP); Hitoshi Katakura, Kanagawa (JP)

(72) Inventors: Hirokazu Odagiri, Miyagi (JP); Mitsunari Hoshi, Miyagi (JP); Shinya Suzuki, Miyagi (JP); Jiro Nozaki, Miyagi (JP); Hitoshi Katakura, Kanagawa (JP)

(73) Assignee: Sony Corporation, Tokyo (JP)

(21) Appl. No.: 13/588,550

(22) Filed: Aug. 17, 2012

(30) Foreign Application Priority Data
Aug. 24, 2011 (JP) 2011-182754

(51) Int. Cl. B29C 59/02; B05D 5/06; B32B 33/00; G02B 5/30

(52) U.S. Cl. 427/162; 359/492.01; 264/1.1; 428/195.1

(57) ABSTRACT

A method of manufacturing an alignment film includes directly pressing a master having fine linear concavity-convexity in order of nanometer on a surface thereof to a surface of a base film at a temperature lower than a glass transition temperature of the base film, and thereby transferring a pattern corresponding to the concavity-convexity on the master to the surface of the base film.

### BACKGROUND

The present technology relates to an alignment film that aligns, for example, a liquid crystalline monomer, and to a method of manufacturing the alignment film. In addition, the present technology relates to a retardation film that changes a polarization state of light, and to a method of manufacturing the retardation film.

There has been a stereoscopic image display of a type using polarizing glasses, in which left-eye pixels and right-eye pixels emit light having different polarization states. In such a display, while a viewer wears polarizing glasses, light emitted from each left-eye pixel is allowed to be incident only on a left eye, and light emitted from each right-eye pixel is allowed to be incident only on a right eye, so that the viewer is allowed to view a stereoscopic image.

For example, Japanese Patent No. 3360787 discloses use of a retardation film to allow left-eye pixels and right-eye pixels to emit light having different polarization states. This retardation film has first retardation regions, each of which has a slow axis in a first direction, corresponding to left-eye pixels, and has second retardation regions, each of which has a slow axis in a second direction different from the first direction, corresponding to right-eye pixels.

### SUMMARY

The above-described retardation film is formed in the following manner, for example. First, a UV curing resin is applied on a surface of a film base with a readily-adhering layer therebetween, and then a pattern is transferred onto the applied UV curing resin, so that an alignment film having an alignment layer on the film base is formed. Then, a liquid crystalline monomer is applied on the alignment film, and the applied liquid crystalline monomer is heated to be cured, so that the retardation film having the retardation layer on the alignment film is formed. In this way, formation of the retardation film takes many process steps.

Recently, a pattern having an alignment function has been tried to be directly provided on a film base by, for example, a melt extrusion process in order to reduce the number of process steps. In the melt extrusion process, however, molding strain occurs during cooling and remains within the film base, leading to dimensional shrinkage of the film base with the lapse of time after molding. Such progress of dimensional shrinkage for a long time specifically corresponds to a change in a relative positional-relationship between a retardation region and pixels even after the retardation film is mounted on a display. This may extremely impair stereoscopic performance, leading to a reduction in salability. Hence, dimensions of the film base need to be stable particularly after the retardation film is mounted on the display. In this way, although the melt extrusion process achieves reduction of the number of process steps, the melt extrusion process does not allow the dimensions of the film base to be stable.

It is desirable to provide a method of manufacturing an alignment film and a method of manufacturing a retardation film, each of which allows dimensions of a film base to be stable while reducing the number of process steps. In addition, it is desirable to provide an alignment film and a retardation film formed by such methods.

A method of manufacturing an alignment film according to an embodiment of the present technology includes directly pressing a master having fine linear concavity-convexity in order of nanometer on a surface thereof to a surface of a base film at a temperature lower than a glass transition temperature of the base film, and thereby transferring a pattern corresponding to the concavity-convexity on the master to the surface of the base film.

A method of manufacturing a retardation film according to an embodiment of the present technology includes: directly pressing a master having fine linear concavity-convexity in order of nanometer on a surface thereof to a surface of a base film at a temperature lower than a glass transition temperature of the base film, and thereby transferring a pattern corresponding to the concavity-convexity on the master to the surface of the base film; and directly disposing a solution containing a liquid crystalline monomer on the surface of the base film having the pattern to align the liquid crystalline monomer, and then polymerizing the aligned liquid crystalline monomer.

In the method of manufacturing the alignment film and the method of manufacturing the retardation film according to the embodiments of the present technology, the master having the fine linear concavity-convexity in the order of nanometer on the surface thereof is directly pressed to the surface of the base film at the temperature lower than the glass transition temperature of the base film. This allows formation of concavity-convexity in such a manner that no molding strain in an in-plane direction remains within the base film. In addition, this allows the alignment film to be formed in a small number of process steps compared with a case where an alignment film is formed on a base film.

The alignment film according to an embodiment of the present technology includes fine linear concavity-convexity in order of nanometer on a surface of a base film. The concavity-convexity is formed by directly pressing a master having a pattern corresponding to the concavity-convexity on a surface thereof to the surface of the base film at a temperature lower than a glass transition temperature of the base film.

A retardation film according to an embodiment of the present technology includes: a base film having fine linear concavity-convexity in order of nanometer on a surface thereof; and a retardation layer being directly in contact with the surface of the base film, and having a slow axis corresponding to the concavity-convexity on the base film. The concavity-convexity is formed by directly pressing a master having a pattern corresponding to the concavity-convexity on a surface thereof to the surface of the base film at a temperature lower than a glass transition temperature of the base film.

In the alignment film and the retardation film according to the embodiments of the present technology, the alignment film is formed by directly pressing the master having the fine linear concavity-convexity in the order of nanometer on the surface of the master to the surface of the base film at the temperature lower than the glass transition temperature of the base film. As a result, little molding strain in an in-plane direction remains within the alignment film. In addition, the concavity-convexity is directly formed on the surface of the base film in the embodiments of the technology. As a result, the alignment film is formed in a small number of process steps compared with a case where an alignment film is formed on a base film.

According to the method of manufacturing the alignment film and the method of manufacturing the retardation film according to the embodiments of the present technology, concavity-convexity is formed while little molding strain in an in-plane direction remains within a base film, and the alignment film is formed in a small number of process steps. This allows dimensions of the film base to be stable while reducing the number of process steps. In addition, the above-described methods allow the alignment film and the retardation film, each film including a film base having stable dimensions, to be provided in a small number of process steps compared with in the past.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a perspective view illustrating an exemplary configuration of a display according to an embodiment of the present technology, together with polarizing glasses.

FIG. 2 is a sectional view illustrating an exemplary internal configuration of the display shown in FIG. 1.

FIG. 3 is a perspective view illustrating an exemplary configuration of a retardation film shown in FIG. 2.

FIG. 4 is a graph for explaining a method of measuring the amount of plastic deformation of a base film.

FIGS. 5A to 5C are tables illustrating an example of the amount of plastic deformation of a base film according to Examples of the embodiment.

FIGS. 6A and 6B are tables illustrating an example of the amount of plastic deformation of a base film according to a comparative example.

FIGS. 7A and 7B are diagrams illustrating an exemplary configuration of an alignment film shown in FIG. 3.

FIG. 8 is a diagram illustrating exemplary slow axes of a retardation layer shown in FIG. 3.

FIGS. 9A and 9B are conceptual diagrams illustrating an exemplary slow axis of each of a right-eye retardation region and a left-eye retardation region shown in FIG. 3, together with slow axes or transmission axes of other optical components.

FIG. 10 is a perspective view illustrating an exemplary configuration of each of a right-eye optical device and a left-eye optical device of the polarizing glasses shown in FIG. 1.

FIG. 11 is a diagram illustrating an exemplary method of manufacturing the alignment film shown in FIGS. 7A and 7B.

FIG. 12 is a diagram illustrating an exemplary method of manufacturing the retardation film shown in FIG. 3.

FIGS. 13A and 13B are conceptual diagrams for explaining an example of transmission axes and of slow axes in viewing of an image on the display shown in FIG. 1 by a right eye.

FIGS. 14A and 14B are conceptual diagrams for explaining another example of transmission axes and of slow axes in viewing of an image on the display shown in FIG. 1 by a right eye.

FIGS. 15A and 15B are conceptual diagrams for explaining an example of transmission axes and of slow axes in viewing of an image on the display shown in FIG. 1 by a left eye.

FIGS. 16A and 16B are conceptual diagrams for explaining another example of transmission axes and of slow axes in viewing of an image on the display shown in FIG. 1 by a left eye.

FIG. 17 is a graph illustrating an example of dimension change rate of an alignment film according to each of Example of the embodiment and a comparative example.

### DETAILED DESCRIPTION OF EMBODIMENTS

Hereinafter, an embodiment of the present technology will be described in detail with reference to the accompanying drawings. It is to be noted that description is made in the following order.

1. Embodiment
1.1. Configuration of Display
1.2. Configuration of Polarizing Glasses
1.3. Manufacturing Method
1.4. Basic Operation
1.5 Effects

2. Modifications

### 1. Embodiment

### [1.1. Configuration of Display 1]

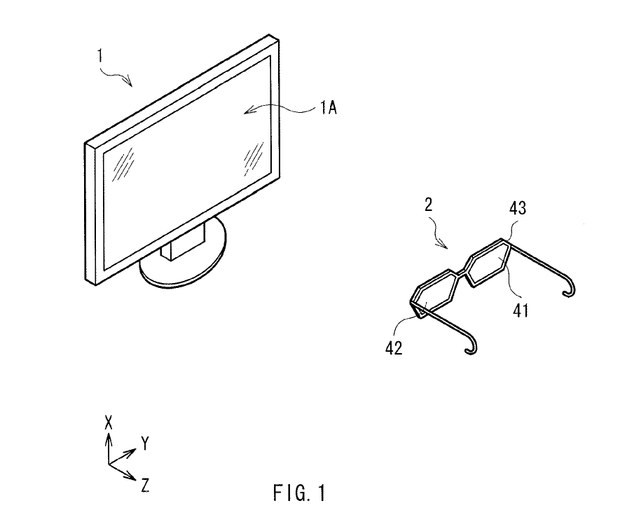

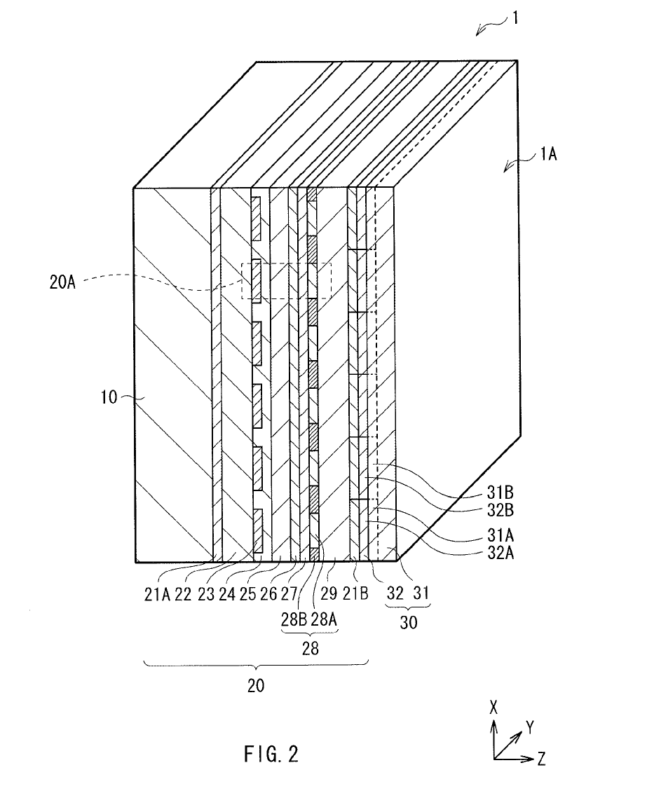

FIG. 1 perspectively illustrates a display 1 according to an embodiment of the present technology together with polarizing glasses 2 described later. FIG. 2 illustrates an exemplary sectional configuration of the display 1 shown in FIG. 1. The display 1 is of a polarizing-glasses type, which displays a stereoscopic image to a viewer (not illustrated) wearing the polarizing glasses 2 in front of his/her eye balls. The display 1 includes a backlight unit 10, a liquid crystal display panel 20, and a retardation film 30 stacked in this order. In the display 1, the surface of the retardation film 30 corresponds to an image display surface 1A directed toward the viewer.

In the embodiment, the display 1 is disposed such that the image display surface 1A is parallel to a perpendicular surface (vertical surface). The image display surface 1A has, for example, a rectangular shape, where a longitudinal direction of the image display surface 1A is, for example, parallel to a horizontal direction (y-axis direction in the drawing). The viewer views the image display surface 1A while wearing the polarizing glasses 2 in front of his/her eye balls. The polarizing glasses 2 are of a circular polarization type, and the display 1 is a display for circular polarization glasses.

### (Backlight Unit 10)

The backlight unit 10 illuminates the liquid crystal display panel 20 from the back, and, for example, includes a reflector, a light source, and an optical sheet, which are all not illustrated. The reflector returns light emitted from the light source toward the optical sheet, and has functions of reflection, scattering, and diffusion of light. Examples of the light source include a plurality of linear light sources arranged in parallel at equal intervals, and a plurality of dot light sources arranged two-dimensionally. It is to be noted that examples of the linear light source include a hot cathode fluorescent lamp (HCFL) and a cold cathode fluorescent lamp (CCFL). Examples of the dot light source include a light emitting diode (LED). The optical sheet may make in-plane luminance distribution of light from the light source to be uniform, and may adjust a divergence angle or a polarization state of light from the light source to be within a desired range, and, for example, may include a diffuser plate, a diffuser sheet, a prism sheet, a reflective polarization device, a retardation plate, and the like. It is to be noted that the light source may be of an edge light type. In such a case, a light guide plate or a light guide film is used as necessary.

### (Liquid Crystal Display Panel 20)

The liquid crystal display panel 20 is a transmissive display panel including a plurality of pixels arranged two-dimensionally, and displays an image through driving pixels in response to image signals. For example, as shown in FIG. 2, the liquid crystal display panel 20 includes a polarizer 21A, a transparent substrate 22, pixel electrodes 23, an alignment film 24, a liquid crystal layer 25, an alignment film 26, a common electrode 27, a color filter 28, a transparent substrate 29, and a polarizer 21B in this order of closeness to the backlight unit 10.

The polarizer 21A is a polarizing plate disposed on a light incidence side of the liquid crystal display panel 20, and the polarizer 21B is a polarizing plate disposed on a light emission side thereof. Each of the polarizers 21A and 21B is a type of an optical shutter, and transmits light (polarized light) in a certain oscillation direction. For example, the polarizers 21A and 21B are each disposed such that their polarizing axes are different from each other by a predetermined angle (for example, 90 degrees), so that light emitted from the backlight unit 10 is transmitted or blocked by the liquid crystal layer. It is to be noted that the polarizing plate is not limited to a plate-like shape.

The direction of the transmission axis of the polarizer 21A is set within a range where light emitted from the backlight unit 10 is allowed to be transmitted. For example, in the case where a polarizing axis of light emitted from the backlight unit 10 is in a perpendicular direction, the transmission axis of the polarizer 21A is also in the perpendicular direction. In the case where a polarizing axis of light emitted from the backlight unit 10 is in a horizontal direction, the transmission axis of the polarizer 21A is also in the horizontal direction. It is to be noted that light emitted from the backlight unit 10 may be circularly polarized light, elliptically polarized light, or non-polarized light without being limited to the linearly polarized light.

The direction of the polarizing axis of the polarizer 21B is set within a range where light transmitted by the liquid crystal display panel 20 is allowed to be transmitted. For example, in the case where the polarizing axis of the polarizer 21A is in the horizontal direction, the polarizing axis of the polarizer 21B is in a direction (perpendicular direction) orthogonal to the polarizing axis of the polarizer 21A. In addition, for example, in the case where the polarizing axis of the polarizer 21A is in the perpendicular direction, the polarizing axis of the polarizer 21B is in a direction (horizontal direction) orthogonal to the polarizing axis of the polarizer 21A. It is to be noted that the polarizing axis is synonymous with the transmission axis.

The transparent substrates 22 and 29 are typically transparent to visible light. It is to be noted that the transparent substrate 22 on a backlight unit 10 side has, for example, active drive circuits including thin film transistors (TFTs) as drive devices electrically connected to the pixel electrodes 23, wirings, and the like. The pixel electrodes 23 include, for example, indium tin oxide (ITO), and functions as electrodes for individual pixels. Each of the alignment films 24 and 26 includes a polymer material such as polyimide, and serves to align the liquid crystal. The liquid crystal layer 25 includes a liquid crystal of, for example, a vertical alignment (VA) mode, an in-plane switching (IPS) mode, a twisted nematic (TN) mode, or a super twisted nematic (STN) mode. The liquid crystal layer 25 has a function of transmitting or blocking light emitted from the backlight unit 10 for each pixel in response to a voltage applied from an undepicted drive circuit. The common electrode 27 includes, for example, ITO, and functions as a counter electrode common to the pixel electrodes 23.

The color filter 28 includes a plurality of filter sections 28A disposed in correspondence to the pixel electrodes 23, and a black matrix section 28B disposed in correspondence to a peripheral region of the pixel electrodes 23. The filter sections 28A are light-transmissive, and perform color separation of light emitted from the backlight unit 10 into red, green, and blue, for example. The black matrix section 28B has a light-blocking property. Each portion of the liquid crystal display panel 20 facing the filter sections 28A configures a pixel 20A of the liquid crystal display panel 20, and the filter section 28A is disposed on a side closer to the image display surface 1A in the pixel 20A.

### (Retardation Film 30)

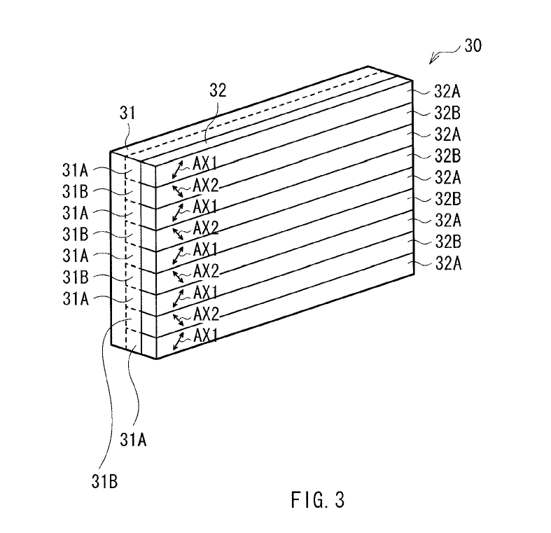

The retardation film 30 is now described. FIG. 3 perspectively illustrates an exemplary configuration of the retardation film 30. The retardation film 30 changes a polarization state of light transmitted by the polarizer 21B of the liquid crystal display panel 20. The retardation film 30 is bonded to the surface (polarizer 21B) on a light emission side of the liquid crystal display panel 20 by an adhesive (not illustrated) and/or the like. For example, as shown in FIGS. 2 and 3, the retardation film 30 includes an alignment film 31 and a retardation layer 32 in this order of closeness to the image display surface 1A. It is to be noted that the alignment film 31 and the retardation layer 32 may be disposed in this order of closeness to the liquid crystal display panel 20, which is, however, not illustrated.

The alignment film 31 is configured of a resin film having a predetermined property. For example, the alignment film 31 can be a single-layer resin film having the predetermined property, or can be a multilayer resin film including a resin layer having the predetermined property on its top surface. Here, “predetermined property” refers to the following property: when a diamond lattice having a facial angle of 136 degrees is pressed into a surface of a base film (a single-layer resin film or a multilayer resin film including the resin layer on its top surface) at a force enough to allow arrival of the diamond lattice at a plastic deformation region in a surface layer of the base film, and then the pressing force is released, the amount of plastic deformation remaining in the base film satisfies the following expression (1). It is to be noted that the measurement of the predetermined property is performed on a film (base film 31D described later) before formation of concavity-convexity on the surface of the alignment film 31. Here, “force enough to allow arrival at a plastic deformation region” is, for example, 1 mN or more.

Dp≧0.25×Dmax (1)

Dp: the amount of plastic deformation remaining in the base film 31D after releasing the pressing force.

Dmax: the maximum amount of pressing deformation after pressing the diamond lattice into the surface of the base film 31D at a force of 1 mN.

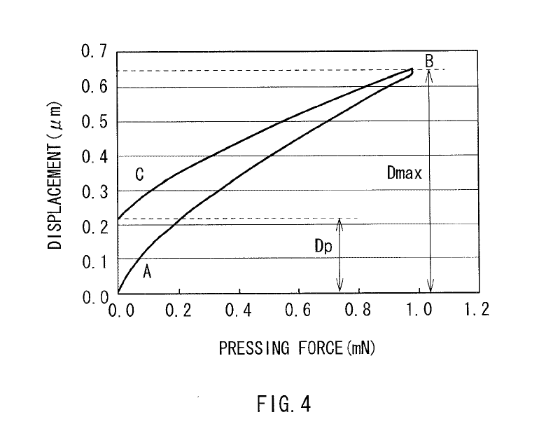

Dp and Dmax in the expression (1) are allowed to be measured by a Vickers hardness tester. For example, as shown in FIG. 4, the pressing force is gradually increased from zero (A in the drawing) to 1 mN (B in the drawing). After the pressing force reaches 1 mN, the pressing force is gradually decreased to zero (C in the drawing). During this operation, the amount of plastic deformation (displacement) is continuously measured. The Dmax in the expression (1) is a value obtained by measuring displacement at the point of B in the drawing at which the pressing force reaches 1 mN. The Dp in the expression (1) is a value obtained by measuring displacement at the point of C in the drawing at which the pressing force is released and decreased to 0 mN.

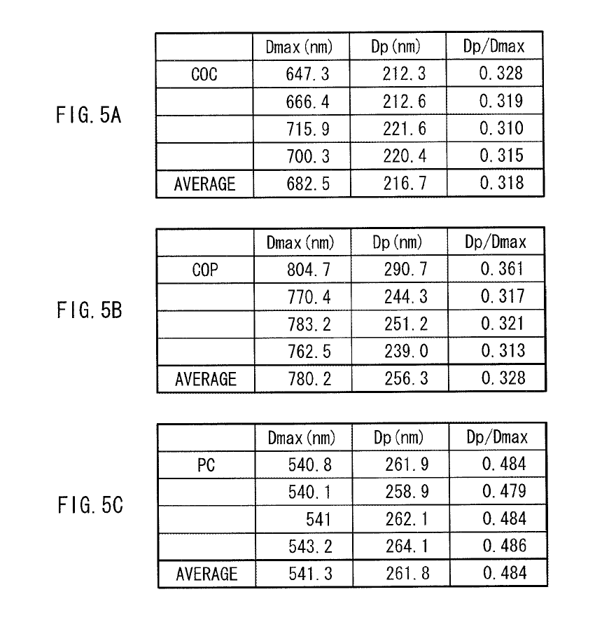

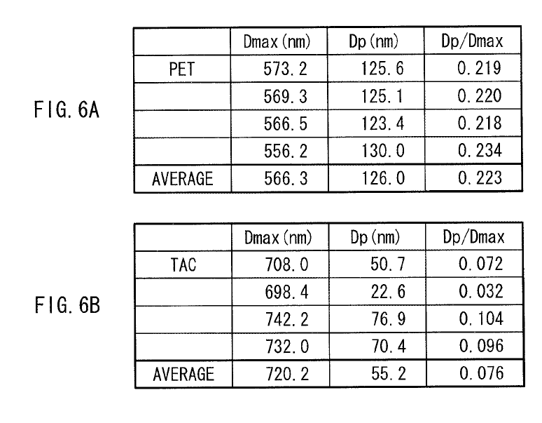

As shown in FIGS. 5A to 5C, examples of a material satisfying the expression (1) include cycloolefin-based resin such as cycloolefin polymer (COP) and cycloolefin copolymer (COC), and thermoplastic resin such as polycarbonate (PC). As shown in FIGS. 6A and 6B, examples of a material unsatisfying the expression (1) include polyethylene terephthalate (PET) and triacetylcellulose (TAC).

The alignment film 31 is formed by a non-heating direct transfer process or a low-temperature-heating direct transfer process. Here, “non-heating” refers to that heating by a heater and/or the like is not intentionally performed during transfer. In addition, “low-temperature-heating” refers to that heating is performed at a temperature lower than the glass transition temperature of the base film 31D during transfer. The “direct transfer process” refers to a process of directly pressing concavity-convexity on a master to a surface of a base film, and transferring a pattern corresponding to the concavity-convexity on the master to the surface of the base film through plastic deformation. It is to be noted that the non-heating direct transfer process and the low-temperature-heating direct transfer process are described in detail later.

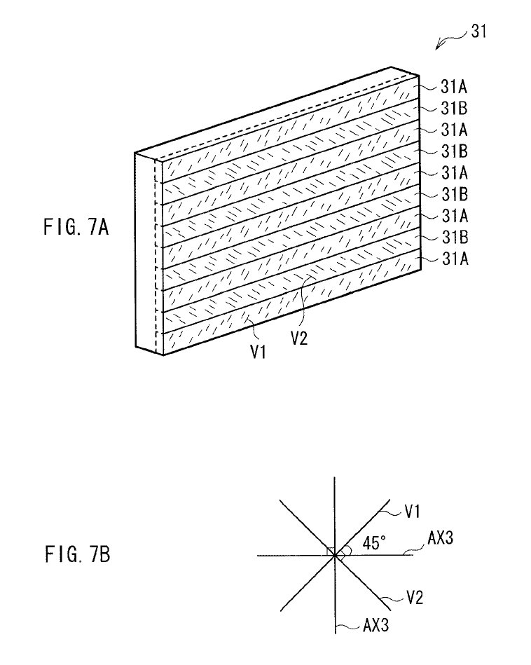

The alignment film 31 has a function of aligning an alignable material such as liquid crystal in a particular direction. For example, as shown in FIGS. 3 and 7A, the alignment film 31 has two types of alignment regions (right-eye alignment regions 31A and left-eye alignment regions 31B) having different alignment directions on the surface on a retardation layer 32 side of the alignment film 31. For example, the right-eye alignment regions 31A and the left-eye alignment regions 31B each have a belt-like shape extending in one common direction (horizontal direction), and are alternately disposed in a shorter-side direction (perpendicular direction) of the right-eye alignment regions 31A and the left-eye alignment regions 31B. The right-eye alignment regions 31A and the left-eye alignment regions 31B are disposed in correspondence to the pixels of the liquid crystal display panel 20, and, for example, are arranged at a pitch corresponding to a pixel pitch in a shorter-side direction (perpendicular direction) of the liquid crystal display panel 20.

For example, as shown in FIGS. 7A and 7B, each right-eye alignment region 31A includes a plurality of grooves V1 each extending in a direction intersecting the polarizing axis AX3 of the polarizer 21B at 45 degrees. On the other hand, for example, as shown in FIGS. 7A and 7B, each left-eye alignment region 31B includes a plurality of grooves V2 each extending in a direction that intersects the polarizing axis AX3 of the polarizer 21B at 45 degrees and is orthogonal to the extending direction of the groove V1. For example, as shown in FIG. 7B, in the case where the polarizing axis AX3 of the polarizer 21B is in the perpendicular or horizontal direction, the grooves V1 and V2 each extend in an oblique (45-degree) direction. In the case where the polarizing axis AX3 of the polarizer 21B is in an oblique (45-degree) direction, each groove V1 extends in, for example, a horizontal direction, while each groove V2 extends in, for example, a perpendicular direction, which is, however, not illustrated.

Each of the grooves V1 and V2 can extend linearly in one direction, or can extend in one direction while fluctuating or meandering, for example. A sectional shape of each of the grooves V1 and V2 is, for example, a V shape. The pitch of each of the grooves V1 and V2 is preferably small, or is preferably in the order of nanometer (less than one micrometer). The depth of each of the grooves V1 and V2 is preferably one fifth or more of the pitch. In consideration of ease of manufacturing, however, the pitch of each of the grooves V1 and V2 is preferably 50 nm or more and less than 1 μm, and the depth thereof is preferably 10 nm or more and less than 250 nm. If the depth of each of the grooves V1 and V2 is less than one fifth of the pitch, it is difficult to correctly align the liquid crystalline monomer during production. If the depth of each of the grooves V1 and V2 is 1 μm or more, slight haze tends to occur due to a difference in a refractive index between the base film and the liquid crystal layer.

The retardation layer 32 is a thin layer having optical anisotropy. The retardation layer 32 is provided directly in contact with the surface of the alignment film 31 (the right-eye alignment regions 31A and the left-eye alignment regions 31B). The retardation layer 32 has slow axes corresponding to the concavity-convexity on the alignment film 31. For example, as shown in FIG. 3, the retardation layer 32 has two types of retardation regions (right-eye retardation regions 32A and left-eye retardation regions 32B) having different slow-axis directions. The right-eye retardation regions 32A are provided directly in contact with the right-eye alignment regions 31A, and the left-eye retardation regions 32B are provided directly in contact with the left-eye alignment regions 31B.

For example, as shown in FIG. 3, the right-eye retardation regions 32A and the left-eye retardation regions 32B each have a belt-like shape extending in one common direction (horizontal direction), and are alternately disposed in a shorter-side direction (perpendicular direction) of the right-eye retardation regions 32A and the left-eye retardation regions 32B. The right-eye retardation regions 32A and the left-eye retardation regions 32B are each disposed in correspondence to the pixels of the liquid crystal display panel 20, and, for example, are arranged at a pitch corresponding to a pixel pitch in a shorter-side direction (perpendicular direction) of the liquid crystal display panel 20.

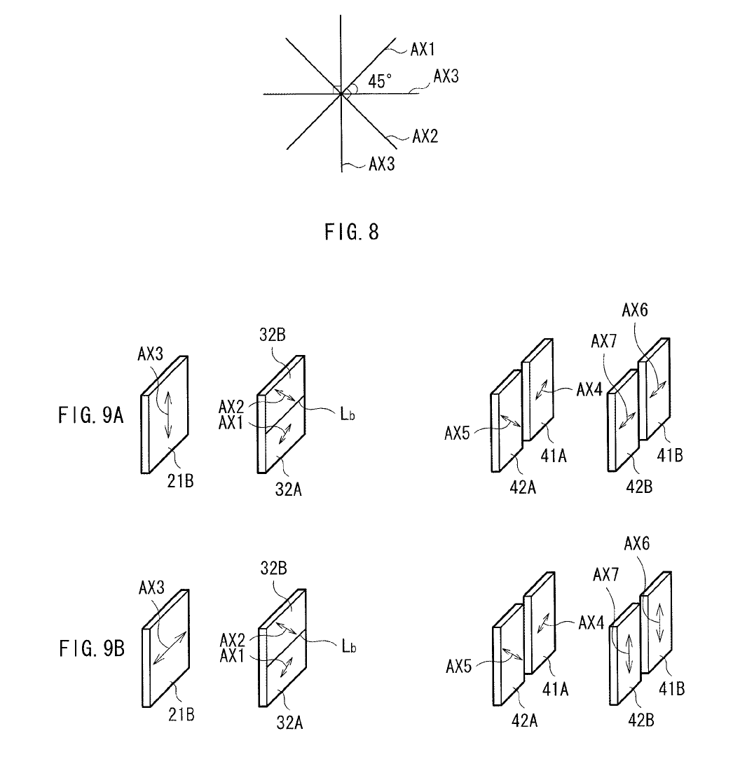

For example, as shown in FIGS. 3 and 8, each right-eye retardation region 32A has a slow axis AX1 in a direction intersecting the polarizing axis AX3 of the polarizer 21B at 45 degrees. On the other hand, for example, as shown in FIGS. 3 and 8, each left-eye retardation region 32B has a slow axis AX2 in a direction that intersects the polarizing axis AX3 of the polarizer 21B at 45 degrees, and is orthogonal to the slow axis AX1. For example, as shown in FIG. 8, in the case where the polarizing axis AX3 of the polarizer 21B is in the perpendicular or horizontal direction, the slow axes AX1 and AX2 are each in an oblique (45-degree) direction. In the case where the polarizing axis AX3 of the polarizer 21B is in an oblique (45-degree) direction, the slow axis AX1 is, for example, in the horizontal direction, and the slow axis AX2 is, for example, in the perpendicular direction, which is, however, not illustrated. The slow axis AX1 is in the extending direction of the groove V1, and the slow axis AX2 is in the extending direction of the groove V2.

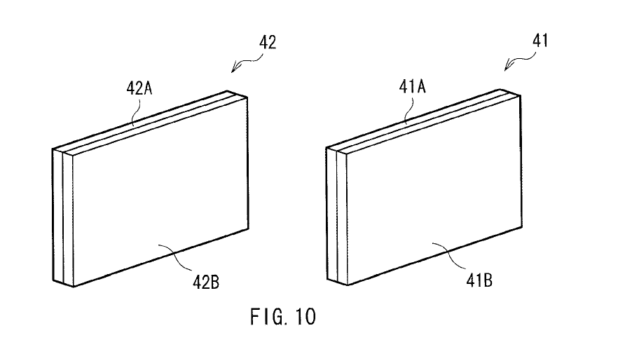

Furthermore, for example, as shown in FIGS. 9A and 9B, the slow axis AX1 is in a direction that is equal to the direction of a slow axis AX4 of a right-eye retardation plate 41A (described later) of the polarizing glasses 2, and is different from the direction of a slow axis AX5 of a left-eye retardation plate 42A (described later) of the polarizing glasses 2. On the other hand, for example, the slow axis AX2 is in a direction that is equal to the direction of the slow axis AX5 and is different from the direction of the slow axis AX4.

The retardation layer 32 is configured of, for example, a polymerized polymer liquid crystal material. In other words, an alignment state of liquid crystal molecules is fixed in the retardation layer 32. The polymer liquid crystal material includes a material selected depending on phase-transition temperature (liquid crystal phase-isotropic phase), wavelength dispersion characteristics of a refractive index of a liquid crystal material, viscosity characteristics, process temperature, and/or the like.

In the retardation layer 32, the major axes of the liquid crystal molecules are arranged along the extending direction of the groove V1 in the vicinity of the interface of each groove V1 and each right-eye retardation region 32A, and the major axes of the liquid crystal molecules are arranged along the extending direction of the groove V2 in the vicinity of the interface of each groove V2 and each left-eye retardation region 32B. Specifically, alignment of the liquid crystal molecules is controlled by the shape and the extending direction of each of the grooves V1 and V2, so that the optical axis of each of the right-eye retardation region 32A and the left-eye retardation region 32B is set.

In addition, a constitutional material, the thickness, and/or the like of each of the right-eye retardation region 32A and the left-eye retardation region 32B of the retardation layer 32 is adjusted, so that a retardation value of each of the right-eye retardation region 32A and the left-eye retardation region 32B is set. The retardation value is preferably set in consideration of retardation of the base 31 as well if the base 31 has retardation. It is to be noted that the right-eye retardation region 32A and the left-eye retardation region 32B are configured of the same material and have the same thickness, resulting in their absolute values of retardation being equal to each other.

### [1.2 Polarizing Glasses 2]

The polarizing glasses 2 are now described with reference to FIGS. 1 and 10. The polarizing glasses 2 are worn by a viewer (not illustrated) in front of his/her eye balls, and are used by the viewer in viewing of an image appearing on the image display surface 1A of the display 1. The polarizing glasses 2 are, for example, circular polarization glasses. For example, as shown in FIG. 1, the polarizing glasses 2 include a right-eye optical device 41, a left-eye optical device 42, and a frame 43.

The frame 43 supports the right-eye optical device 41 and the left-eye optical device 42. For example, as shown in FIG. 1, the frame 43 has, but is not limited to, a shape allowing a viewer (not illustrated) to hang the frame 43 on his/her nose and ears. The right-eye optical device 41 and the left-eye optical device 42 are used while facing the image display surface 1A of the display 1. Although the right-eye optical device 41 and the left-eye optical device 42 are preferably used in a manner of being disposed in one horizontal plane as much as possible as shown in FIG. 1, the right-eye optical device 41 and the left-eye optical device 42 may be used in a manner of being disposed in a slightly inclined plane.

For example, as shown in FIG. 10, the right-eye optical device 41 includes the right-eye retardation plate 41A and a polarizing plate 41B. The right-eye retardation plate 41A and the polarizing plate 41B are disposed in this order of closeness to the display 1. On the other hand, for example, as shown in FIG. 10, the left-eye optical device 42 includes the left-eye retardation plate 42A and a polarizing plate 42B. The left-eye retardation plate 42A and the polarizing plate 42B are disposed in this order of closeness to the display 1.

Each of the right-eye optical device 41 and the left-eye optical device 42 may have a component other than those exemplified above. For example, a protective film (not illustrated) or a coating layer (not illustrated) for protection, which prevents scattering of broken pieces to eye balls of a viewer when the polarizing plates 41B and 42B are each broken, may be provided on a surface on a light emission side (viewer side) of each of the right-eye optical device 41 and the left-eye optical device 42. For example, as shown in FIG. 10, the right-eye optical device 41 and the left-eye optical device 42 may each have a flat plate-like shape. Alternatively, the optical device 41 and 42 may each have a curved shape (not illustrated) projecting to the light incidence direction.

The polarizing plates 41B and 42B each transmit light (polarized light) in a certain oscillation direction. For example, as shown in FIGS. 9A and 9B, the polarizing axes AX6 and AX7 of the polarizing plates 41B and 42B are each in a direction orthogonal to the polarizing axis AX3 of the polarizer 21B of the display 1. For example, as shown in FIG. 9A, in the case where the polarizing axis AX3 of the polarizer 21B is in the perpendicular direction, the polarizing axes AX6 and AX7 are each in the horizontal direction. For example, as shown in FIG. 9B, in the case where the polarizing axis AX3 of the polarizer 21B is in the horizontal direction, the polarizing axes AX6 and AX7 are each in the perpendicular direction. In the case where the polarizing axis AX3 of the polarizer 21B is in an oblique (45-degree) direction, each of the polarizing axes AX6 and AX7 is in a direction (−45-degree direction) orthogonal to the 45-degree direction, which is, however, not illustrated.

The right-eye retardation plate 41A and the left-eye retardation plate 42A are each a thin layer or film having optical anisotropy. As shown in FIGS. 9A and 9B, the slow axis AX4 of the right-eye retardation plate 41A is in a direction intersecting the polarizing axis AX6 at 45 degrees. As shown in FIGS. 9A and 9B, the slow axis AX5 of the left-eye retardation plate 42A is in a direction that intersects the polarizing axis AX7 at 45 degrees and is orthogonal to the slow axis AX4. For example, as shown in FIGS. 9A and 9B, in the case where the polarizing axes AX6 and AX7 are each in the horizontal or perpendicular direction, the slow axes AX4 and AX5 are each in a direction intersecting each of the horizontal and perpendicular directions. In the case where each of the polarizing axes AX6 and AX7 is in an oblique (45-degree) direction, the slow axis AX4 is, for example, in the horizontal direction, and the slow axis AX5 is, for example, in the perpendicular direction, which is, however, not illustrated.

The slow axis AX4 is in a direction that is equal to the direction of the slow axis AX1 of the right-eye retardation region 32A, and is different from the direction of the slow axis AX2 of the left-eye retardation region 32B. On the other hand, the slow axis AX5 is in a direction that is equal to the direction of the slow axis AX2, and is different from the direction of the slow axis AX1.

### [1.3 Manufacturing Method]

An exemplary method of manufacturing the retardation film 30 is now described. In the following, first, an exemplary method of manufacturing the alignment film 31 corresponding to the base of the retardation film 30 is described. Then, an exemplary method of manufacturing the retardation film 30 using the alignment film 31 is described.

### (Method of Manufacturing Alignment Film 31)

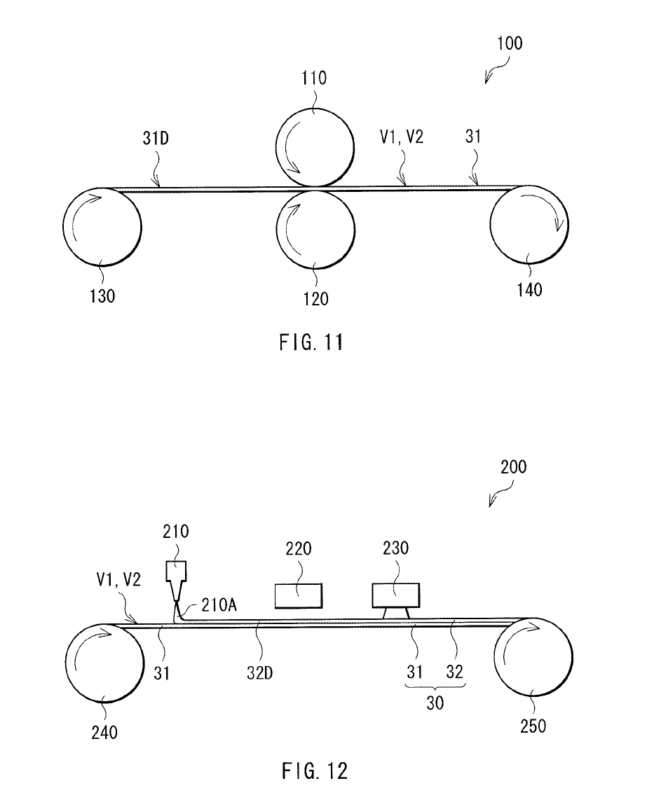

FIG. 11 illustrates an exemplary method of manufacturing the alignment film 31. A manufacturing apparatus 100 shown in FIG. 11 includes a roll-like master 110 and a nip roll 120 opposed to the roll-like master 110. The manufacturing apparatus 100 further includes a roll 130 unwinding the base film 31D, and a roll 140 winding the manufactured alignment film 31.

The roll-like master 110 has a pattern, on its surface, corresponding to the concavity-convexity on the surface of the alignment film 31. In detail, the roll-like master 110 has, on its surface, a plurality of first regions including concavity-convexity extending in a first direction, and a plurality of second regions including concavity-convexity extending in a second direction intersecting the first direction. The first and second regions each have a belt-like shape, and are alternately disposed on the surface of the roll-like master 110. The first region has a reverse pattern of the concavity-convexity on the right-eye alignment region 31A, and the second region has a reverse pattern of the concavity-convexity on the left-eye alignment region 31B. In other words, the roll-like master 110 has fine linear concavity-convexity in the order of nanometer on its surface. The base film 31D, which does not have the concavity-convexity on the surface of the alignment film 31 yet, is inserted between the roll-like master 110 and the nip roll 120.

The roll-like master 110 and the nip roll 120 are each configured of a typical pressing material such as carbon steel for general structure, SUS, and bearing steel for high-pressure press. The surface of the nip roll 120 may be covered with a coating of resin such as fluorine resin, silicone, nylon, and polyethylene at a thickness of several tens nanometers, for example. Such a coating helps to allow uniform pressing force to be exerted in a width direction of the nip roll 120.

The base film 31D is configured of a resin film having the above-described “predetermined property”. For example, the base film 31D can be a single-layer resin film having the “predetermined property”, or can be a multilayer resin film including a resin layer having the “predetermined property” on its top surface. The base film 31D has a thickness sufficiently larger than the depth of the pattern formed on the surface of the alignment film 31, for example, has a thickness ten times as large as the depth of the pattern formed on the surface of the alignment film 31. For example, in the case where the depth of the pattern formed on the surface of the alignment film 31 is less than 250 nm, the base film 31D may have a thickness of 100 μm corresponding to about 400 times as large as the depth of the pattern formed on the surface of the alignment film 31.

In the case where the “non-heating direct transfer process” is used, both the roll-like master 110 and the nip roll 120 are not intentionally heated by a heater and/or the like. In this case, therefore, temperature of each of the roll-like master 110 and the nip roll 120 is lower than the glass transition temperature of the base film 31D. In the case where the “low-temperature-heating direct transfer process” is used, one or both of the roll-like master 110 and the nip roll 120 is intentionally heated by a heater and/or the like. However, temperature of each of the roll-like master 110 and the nip roll 120 is lower than the glass transition temperature of the base film 31D. As described above, in either of the cases using the above-described processes, temperature of each of the roll-like master 110 and the nip roll 120 is lower than the glass transition temperature of the base film 31D.

In the manufacturing apparatus 100, first, the base film 31D is unwound from the roll 130, and inserted into a space between the roll-like master 110 and the nip roll 120. In the manufacturing apparatus 100, then, the base film 31D is sandwiched between the roll-like master 110 and the nip roll 120, so that the concavity-convexity on the surface of the roll-like master 110 is directly pressed to the surface of the base film 31D. During this operation, in the manufacturing apparatus 100, the concavity-convexity on the roll-like master 110 is pressed to the surface of the base film 31D at a linear pressure of 200 to 500 kgf/cm or more. Furthermore, in the manufacturing apparatus 100, the concavity-convexity is pressed at a temperature lower than the glass transition temperature of the base film 31D.

A resin film or a resin layer satisfying the expression (1) is used for the base film 31D. As a result, even if the base film 31D is not heated at a temperature equal to or higher than the glass transition temperature of the base film 31D, the concavity-convexity on the roll-like master 110 is pressed to the surface of the base film 31D at a linear pressure equal to or higher than the above-described linear pressure to plastically deform the surface of the base film 31D, so that the manufacturing apparatus 100 allows the pattern corresponding to the concavity-convexity on the roll-like master 110 to be transferred to the surface of the base film 31D. In this way, the alignment film 31 is manufactured. In the manufacturing apparatus 100, then, the manufactured alignment film 31 is wound on the roll 140.

### (Method of Manufacturing Retardation Film 30)

FIG. 12 illustrates an exemplary method of manufacturing the retardation film 30. A manufacturing apparatus 200 shown in FIG. 12 includes a discharger 210 that drops a liquid crystal, a heater 220 that heats the dropped liquid crystal for alignment, and a UV irradiator 230 that cures the aligned liquid crystal. The manufacturing apparatus 200 further includes a roll 240 unwinding the alignment film 31, and a roll 250 winding the manufactured retardation film 30.

In the manufacturing apparatus 200, first, the alignment film 31 is unwound from the roll 240. In the manufacturing apparatus 200, then, a liquid crystal 210A containing a liquid crystalline monomer is dropped from the discharger 210 onto the surface of the unwound alignment film 31 to form a liquid crystal layer 32D. In the manufacturing apparatus 200, then, the liquid crystalline monomer in the liquid crystal layer 32D applied on the surface of the alignment film 31 is aligned (heated) by the heater 220, and then the liquid crystal layer 32D is gradually cooled to a temperature slightly lower than the phase transition temperature. Consequently, the liquid crystalline monomer aligns in accordance with the patterns of the plurality of grooves V1 and V2 provided on the surface of the alignment film 31. In other words, the liquid crystalline monomer aligns along the extending directions of the plurality of grooves V1 and V2.

In the manufacturing apparatus 200, then, ultraviolet rays are applied to the aligned liquid crystal layer 32D from the UV irradiator 230 in order to polymerize the liquid crystalline monomer in the liquid crystal layer 32D. It is to be noted that, while the treatment temperature is typically near room temperature, the temperature may be raised to the phase transition temperature or lower in order to adjust a retardation value. Consequently, an alignment state of the liquid crystal molecules is fixed along the extending directions of the plurality of grooves V1 and V2, leading to formation of the retardation layer 32 (the right-eye retardation regions 32A and the left-eye retardation regions 32B). This is the end of manufacturing of the retardation film 30. In the manufacturing apparatus 200, then, the retardation film 30 is wound on the roll 250.

Although the above description has been made with an exemplary case where the alignment film 31 and the retardation film 30 are manufactured using rolls, the alignment film 31 and the retardation film 30 are also allowed to be manufactured in a sheet-feeding manner, or using a plate-like master.

### [1.4 Basic Operation]

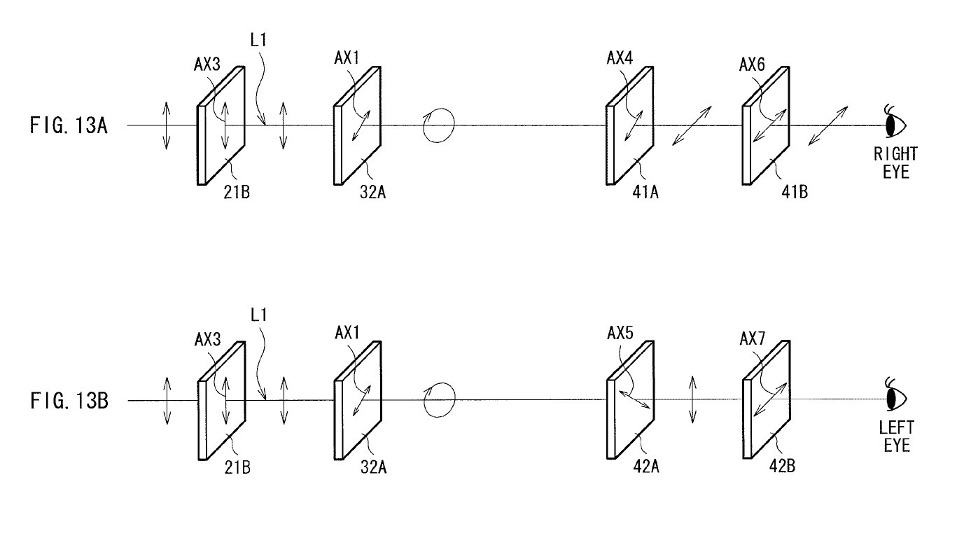

An exemplary basic operation for image display by the display 1 of the embodiment is now described with reference to FIG. 13A to FIG. 16B.

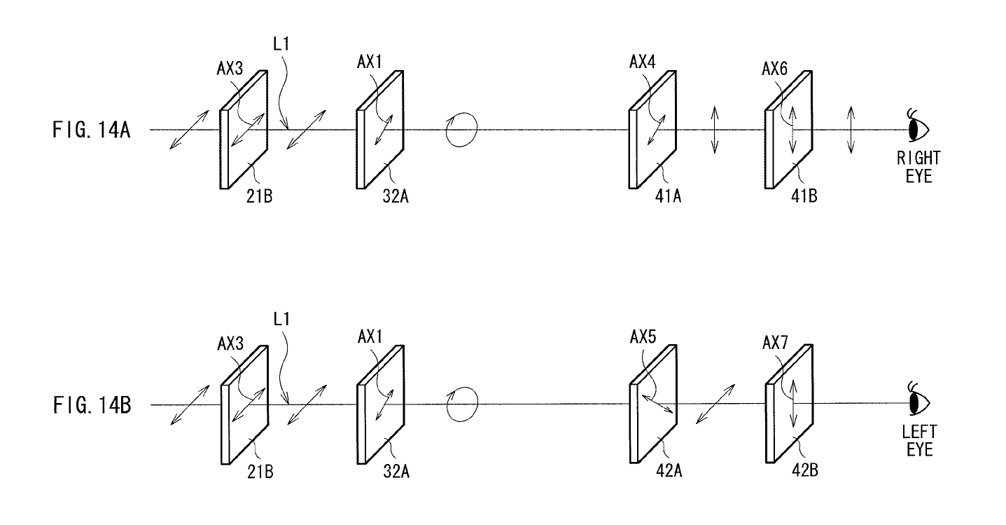

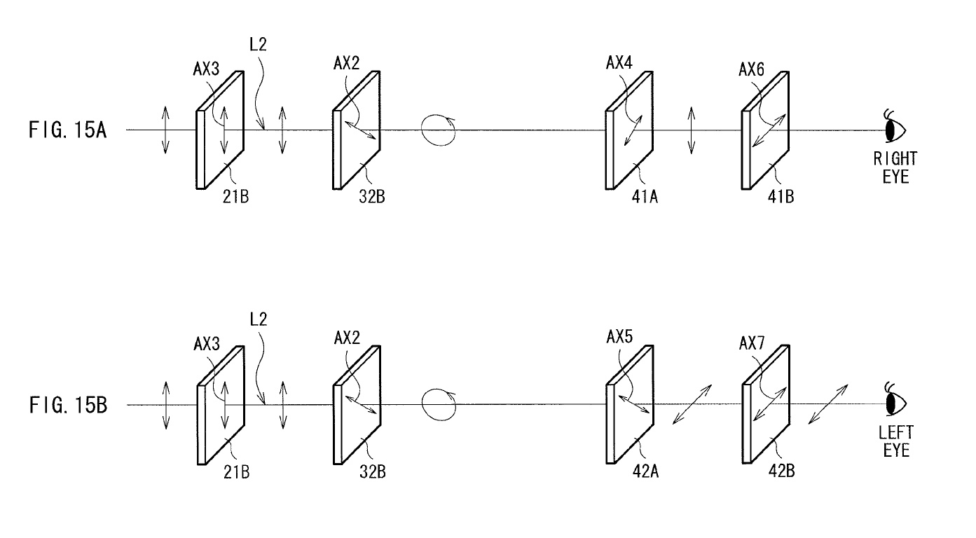

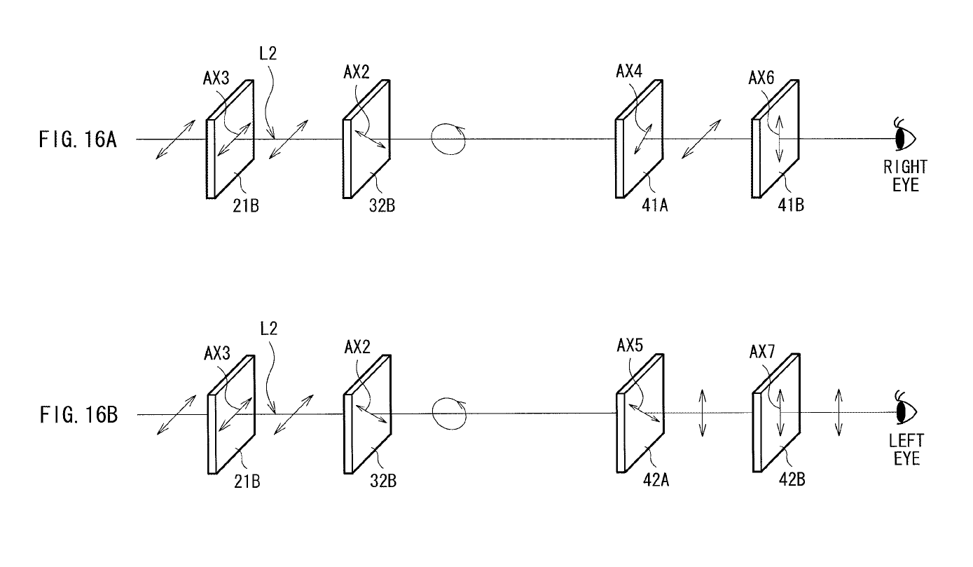

First, while light applied from the backlight unit 10 is incident on the liquid crystal display panel 20, parallax signals including a right-eye image and a left-eye image are input to the liquid crystal display panel 20 as image signals. In response to this, right-eye image light L1 is output from pixels on odd-numbered lines (FIGS. 13A and 13B or FIGS. 14A and 14B), and left-eye image light L2 is output from pixels on even-numbered lines (FIGS. 15A and 15B or FIGS. 16A and 16B). It is to be note that, although the right-eye image light L1 and the left-eye image light L2 are actually mixedly output, the right-eye image light L1 and the left-eye image light L2 are separately illustrated in FIG. 13A to FIG. 16B for convenience of description.

Then, the right-eye image light L1 and the left-eye image light L2 are converted to elliptically-polarized light by the right-eye retardation region 32A and the left-eye retardation region 32B of the retardation film 30, respectively. The converted elliptically-polarized light is transmitted by the alignment film 31 of the retardation film 30, and then is output to the outside through the image display surface of the display 1.

Then, the light output to the outside of the display 1 enters the polarizing glasses 2, and is reconverted from the elliptically-polarized light to the linearly-polarized light by the right-eye retardation plate 41A and the left-eye retardation plate 42A, and then enters the polarizing plates 41B and 42B of the polarizing glasses 2.

In this state, among light incident on the polarizing plates 41B and 42B, a polarizing axis of light corresponding to the right-eye image light L1 is parallel to the polarizing axis AX6 of the polarizing plate 41B (FIGS. 13A and 14A), and is orthogonal to the polarizing axis AX7 of the polarizing plate 42B (FIGS. 13B and 14B). Hence, among light incident on the polarizing plates 41B and 42B, light corresponding to the right-eye image light L1 is transmitted only by the polarizing plate 41B, and then arrives at the right eye of a viewer (FIGS. 13A and 13B or FIGS. 14A and 14B).

On the other hand, among light incident on the polarizing plates 41B and 42B, a polarizing axis of light corresponding to the left-eye image light L2 is orthogonal to the polarizing axis AX6 of the polarizing plate 41B (FIGS. 15A and 16A), and is parallel to the polarizing axis AX7 of the polarizing plate 42B (FIGS. 15B and 16B). Hence, among light incident on the polarizing plates 41B and 42B, light corresponding to the left-eye image light L2 is transmitted only by the polarizing plate 42B, and then arrives at the left eye of the viewer (FIGS. 15A and 15B or FIGS. 16A and 16B).

In this way, light corresponding to the right-eye image light L1 arrives at the right eye of a viewer, and light corresponding to the left-eye image light L2 arrives at the left eye of the viewer. As a result, the viewer virtually recognizes an image as if the image is stereoscopically displayed on the image display surface of the display 1.

### [1.5 Effects]

The effects of the display 1 of the embodiment are now described.

In the past, first, a UV curing resin is applied on a surface of a film base with an readily-adhering layer therebetween, and then a pattern is transferred to the applied UV curing resin, so that an alignment film having an alignment layer on the film base is formed. Then, a liquid crystalline monomer is applied on the alignment film, and the applied liquid crystalline monomer is heated to be cured, so that the retardation film having the retardation layer on the alignment film is formed. In this way, the previous method of forming the retardation film takes many process steps.

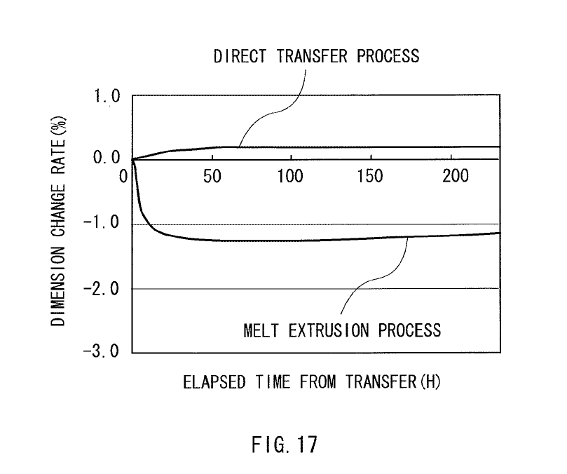

Recently, a pattern having an alignment function has been tried to be directly provided on a film base by, for example, a melt extrusion process in order to reduce the number of process steps. In the melt extrusion process, however, molding strain occurs during cooling and remains within the film base, leading to dimensional shrinkage of the film base with the lapse of time after molding. In the melt extrusion process, for example, as shown in FIG. 17, dimensional shrinkage drastically occurs in the initial stage after transfer, and then dimensional shrinkage gently progresses with the lapse of time. It is to be noted that dimension change rate is about 1.2% in the initial stage in the example shown in FIG. 17.

Such progress of dimensional shrinkage for a long time specifically corresponds to a change in a relative positional relationship between a retardation region and pixels even after the retardation film is mounted on a display. This may extremely impair stereoscopic performance, leading to a reduction in salability. Hence, dimensions of the film base need to be stable particularly after the retardation film is mounted on the display. In this way, although the melt extrusion process achieves reduction of the number of process steps, the melt extrusion process does not allow the dimensions of the film base to be stable.

In contrast, in the embodiment, the roll-like master 110 having fine linear concavity-convexity in the order of nanometer on its surface is directly pressed to the surface of the base film 31D at a temperature lower than the glass transition temperature of the base film 31D during production of the alignment film 31. This allows formation of concavity-convexity in such a manner that little molding strain in an in-plane direction remains within the base film 31D. For example, as shown in FIG. 17, although a slight dimensional change occurs in an initial stage after transfer in the direct transfer process, no dimensional change occurs thereafter despite passing of time. In the example of FIG. 17, initial dimension change rate is as small as 0.15%, which is about one eighth of the initial dimension change rate in the melt extrusion process. Stable dimensions of the alignment film 31 are thus achieved by the direct transfer process. In addition, the alignment film 31 is allowed to be formed thereby in the small number of process steps compared with the method in the past where an alignment film is formed on a base film, and furthermore, a smaller number of types of materials are allowed to be used. Consequently, the embodiment achieves stable dimensions of the alignment film 31 while reducing the number of process steps.

### 2. Modifications

Although the embodiment has been described with an exemplary case where the retardation regions (the right-eye retardation regions 32A and the left-eye retardation regions 32B) of the retardation film 30 extend in a horizontal direction, the retardation regions may extend in another direction. For example, the retardation regions (the right-eye retardation regions 32A and the left-eye retardation regions 32B) of the retardation film 30 may extend in a perpendicular direction, which is, however, not illustrated. In such a case, “perpendicular direction” in the description of the embodiment needs to be replaced by “horizontal direction”, and “horizontal direction” by “perpendicular direction”.

In addition, although the retardation film 30 in the embodiment has two types of retardation regions (the right-eye retardation regions 32A and the left-eye retardation regions 32B) having different slow-axis directions, the retardation film 30 may have three or more types of retardation regions having different slow-axis directions.

In addition, although the embodiment has been described with an exemplary case where the retardation film 30 is bonded to the liquid crystal display panel 20, the retardation film 30 may be bonded to other types of display panels.

Although description has been made hereinbefore on the case where the polarizing glasses 2 are of a circular polarization type, and the display 1 is a display for circular polarization glasses, the present technology may be applied to a case where the polarizing glasses 2 are of a linear polarization type, and the display 1 is a display for linear polarization glasses.

It is to be noted that “equivalent”, “equal”, “parallel”, “orthogonal”, “perpendicular”, and “horizontal” in this specification are intended to include substantially equivalent, substantially equal, substantially parallel, substantially orthogonal, substantially perpendicular, and substantially horizontal, respectively, within the scope without loss of the advantage of the present technology. For example, manufacturing error and error due to various factors such as variation may be included.

It is possible to achieve at least the following configurations from the above-described example embodiments and the modifications of the disclosure.

(1) A method of manufacturing an alignment film, the method including

directly pressing a master having fine linear concavity-convexity in order of nanometer on a surface thereof to a surface of a base film at a temperature lower than a glass transition temperature of the base film, and thereby transferring a pattern corresponding to the concavity-convexity on the master to the surface of the base film.

(2) The method according to (1), wherein the base film is a single-layer or multilayer resin film.

(3) The method according to (1) or (2), wherein the base film includes a material having an amount of plastic deformation that satisfies an expression below, the amount of plastic deformation remaining in the film when a diamond lattice having a facial angle of 136 degrees is pressed into the surface of the base film at a force enough to allow the diamond lattice to arrive at a plastic deformation region in a surface layer of the base film, and then the pressing force is released,

Dp≧0.25×Dmax,

where Dp is the amount of plastic deformation remaining in the base film when the pressing force is released, and Dmax is a maximum amount of pressing deformation when the diamond lattice is pressed into the surface of the base film at the force of 1 mN.

(4) The method according to any one of (1) to (3), wherein the concavity-convexity on the master includes a plurality of first regions including first concavity-convexity extending in a first direction, and a plurality of second regions including second concavity-convexity extending in a second direction intersecting the first direction, and

the first and second regions each have a belt-like shape, and are alternately disposed.

(5) A method of manufacturing a retardation film, the method including:

directly pressing a master having fine linear concavity-convexity in order of nanometer on a surface thereof to a surface of a base film at a temperature lower than a glass transition temperature of the base film, and thereby transferring a pattern corresponding to the concavity-convexity on the master to the surface of the base film; and

directly disposing a solution containing a liquid crystalline monomer on the surface of the base film having the pattern to align the liquid crystalline monomer, and then polymerizing the aligned liquid crystalline monomer.

(6) The method according to (5), wherein the base film is a single-layer or multilayer resin film.

(7) The method according to (5) or (6), wherein the base film includes a material having an amount of plastic deformation that satisfies an expression below, the amount of plastic deformation remaining in the film when a diamond lattice having a facial angle of 136 degrees is pressed into the surface of the base film at a force enough to allow the diamond lattice to arrive at a plastic deformation region in a surface layer of the base film, and then the pressing force is released,

Dp≧0.25×Dmax,

where Dp is the amount of plastic deformation remaining in the base film when the pressing force is released, and Dmax is a maximum amount of pressing deformation when the diamond lattice is pressed into the surface of the base film at the force of 1 mN.

(8) The method according to any one of (5) to (7), wherein the concavity-convexity on the master includes a plurality of first regions including first concavity-convexity extending in a first direction, and a plurality of second regions including second concavity-convexity extending in a second direction intersecting the first direction, and

the first and second regions each have a belt-like shape, and are alternately disposed.

(9) An alignment film, including

fine linear concavity-convexity in order of nanometer on a surface of a base film,

wherein the concavity-convexity is formed by directly pressing a master having a pattern corresponding to the concavity-convexity on a surface thereof to the surface of the base film at a temperature lower than a glass transition temperature of the base film.

(10) A retardation film, including:

a base film having fine linear concavity-convexity in order of nanometer on a surface thereof; and

a retardation layer being directly in contact with the surface of the base film, and having a slow axis corresponding to the concavity-convexity on the base film,

wherein the concavity-convexity is formed by directly pressing a master having a pattern corresponding to the concavity-convexity on a surface thereof to the surface of the base film at a temperature lower than a glass transition temperature of the base film.

The present disclosure contains subject matter related to that disclosed in Japanese Priority Patent Application JP 2011-182754 filed in the Japan Patent Office on Aug. 24, 2011, the entire content of which is hereby incorporated by reference.

It should be understood by those skilled in the art that various modifications, combinations, sub-combinations, and alterations may occur depending on design requirements and other factors insofar as they are within the scope of the appended claims or the equivalents thereof.

What is claimed is:

1. A method of manufacturing an alignment film, the method comprising
directly pressing a master having fine linear concavity-convexity in order of nanometer on a surface thereof to a surface of a base film at a temperature lower than a glass transition temperature of the base film, and thereby transferring a pattern corresponding to the concavity-convexity on the master to the surface of the base film.

2. The method according to claim 1, wherein the base film is a single-layer or multilayer resin film.

3. The method according to claim 2, wherein the base film includes a material having an amount of plastic deformation that satisfies an expression below, the amount of plastic deformation remaining in the film when a diamond lattice having a facial angle of 136 degrees is pressed into the surface of the base film at a force enough to allow the diamond lattice to arrive at a plastic deformation region in a surface layer of the base film, and then the pressing force is released,
Dp≧0.25×Dmax,
where Dp is the amount of plastic deformation remaining in the base film when the pressing force is released, and Dmax is a maximum amount of pressing deformation when the diamond lattice is pressed into the surface of the base film at the force of 1 mN.

4. The method according to claim 2, wherein the concavity-convexity on the master includes a plurality of first regions including first concavity-convexity extending in a first direction, and a plurality of second regions including second concavity-convexity extending in a second direction intersecting the first direction, and
the first and second regions each have a belt-like shape, and are alternately disposed.

5. A method of manufacturing a retardation film, the method comprising:
directly pressing a master having fine linear concavity-convexity in order of nanometer on a surface thereof to a surface of a base film at a temperature lower than a glass transition temperature of the base film, and thereby transferring a pattern corresponding to the concavity-convexity on the master to the surface of the base film; and
directly disposing a solution containing a liquid crystalline monomer on the surface of the base film having the pattern to align the liquid crystalline monomer, and then polymerizing the aligned liquid crystalline monomer.

6. An alignment film, comprising
fine linear concavity-convexity in order of nanometer on a surface of a base film,
wherein the concavity-convexity is formed by directly pressing a master having a pattern corresponding to the concavity-convexity on a surface thereof to the surface of the base film at a temperature lower than a glass transition temperature of the base film.

7. A retardation film, comprising:
a base film having fine linear concavity-convexity in order of nanometer on a surface thereof; and
a retardation layer being directly in contact with the surface of the base film, and having a slow axis corresponding to the concavity-convexity on the base film,
wherein the concavity-convexity is formed by directly pressing a master having a pattern corresponding to the concavity-convexity on a surface thereof to the surface of the base film at a temperature lower than a glass transition temperature of the base film.
